(19) United States
(12) Patent Application Publication
(10) Pub. No.: US 2008/0118731 A1
(43) Pub. Date: May 22, 2008

(54) Method of forming a structure having a high dielectric constant, a structure having a high dielectric constant, a capacitor including the structure, a method of forming the capacitor

(75) Inventors: Bhaskar Srinivasan, Boise, ID (US); John A. Smythe, Boise, ID (US)

Correspondence Address: TRASK BRITT, P.C./ MICRON TECHNOLOGY, P.O. BOX 2550, SALT LAKE CITY, UT, 84110, US

(73) Assignee: Micron Technology, Inc.

(21) Appl. No.: 11/600,695

(22) Filed: Nov. 16, 2006

(51) Int. Cl. B05D 5/12; H01G 9/00; H01G 4/005

(52) U.S. Cl. 428/220; 427/79; 361/303; 29/25.03

(57) ABSTRACT

A method of forming a dielectric structure, such as a layer, is disclosed. The method comprises forming a high-k structure from a plurality of portions of a high-k material. Each of the plurality of portions of the high-k material is formed by depositing a plurality of monolayers of the high-k material and annealing the high-k material. The high-k material may be a perovskite-type material including, but not limited to, strontium titanate. A dielectric structure, a capacitor incorporating a dielectric structure and a method of forming a capacitor are also disclosed.

### FIELD OF THE INVENTION

Embodiments of the invention relate to forming a structure having a high dielectric constant (k) and a low leakage current. Specifically, embodiments of the invention relate to forming the structure having the high k and low leakage current from a perovskite-type material.

### BACKGROUND OF THE INVENTION

Capacitors are the basic energy storage devices in random access memory devices, such as dynamic random access memory (“DRAM”) devices. Capacitors include two conductors, such as parallel metal or polysilicon plates, which act as electrodes. The electrodes are insulated from each other by a dielectric material. With the continual shrinkage of microelectronic devices, such as capacitors, the materials traditionally used in integrated circuit technology are approaching their performance limits. Silicon dioxide (“SiO₂”) has frequently been used as the dielectric material in capacitors. However, when a thin film of SiO₂ is formed, such as less than 5 nm in thickness, the film has defects, which leads to high leakage. This deficiency has lead to a search for improved dielectric materials. High quality, thin dielectric materials containing Group IIA metal titanates, such as strontium titanate (“SrTiO₃” or “STO”), barium titanate (“BaTiO₃”), or barium strontium titanate (“(Ba₁₋ₓSrₓ)TiO₃”) are of interest to the semiconductor industry because these materials possess higher dielectric constants than SiO₂. These dielectric materials are typically formed by chemical vapor deposition (“CVD”) or atomic layer deposition (“ALD”). However, CVD is unable to provide good step coverage and film stoichiometry in high fill aspect ratio containers. Therefore, CVD is not useful to fill high aspect ratio containers. While ALD provides good step coverage, current CVD and ALD techniques each produce dielectric materials that have high leakage.

To produce a capacitor, a bottom electrode is formed on a semiconductor substrate and a dielectric layer is deposited over the bottom electrode. The bottom electrode and the dielectric layer are annealed, and a top electrode is formed over the dielectric layer. The dielectric layer is typically annealed before the top electrode is formed.

U.S. Published Application No. 20030234417 discloses forming a discontinuous layer of a high-k dielectric material, such as an STO, on a conductor material. The discontinuous layer is formed by ALD. The discontinuous layer is annealed in the presence of a reactive species so that exposed portions of the conductor material are converted to an insulating material.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a cross-sectional view of an embodiment of a high-k structure formed according to the present invention;

FIG. 2 is a cross-sectional view of an embodiment of a DRAM memory device formed according to the present invention;

FIG. 3 is a plot of dielectric constant (k) versus frequency for STO films formed according to embodiments of the present invention;

FIG. 4 is a plot of capacitance density versus frequency for STO films formed according to embodiments of the present invention; and

FIG. 5 is a plot of current versus voltage for STO films formed according to embodiments of the present invention.

### DETAILED DESCRIPTION OF THE INVENTION

The following description provides specific details, such as material types, material thicknesses, and processing conditions in order to provide a thorough description of embodiments of the present invention. However, a person of ordinary skill in the art will understand that the embodiments of the present invention may be practiced without employing these specific details. Indeed, the embodiments of the present invention may be practiced in conjunction with conventional fabrication techniques employed in the industry.

An embodiment of a method of forming a structure, such as an STO layer, having a high k and a low leakage current is disclosed. As used herein, the term “structure” refers to a layer or film, or to a nonplanar mass, such as a three-dimensional mass having a substantially nonplanar configuration. The structure is referred to herein as a “high-k structure.” The high-k structure is formed in multiple portions from a high-k material. Each portion of the high-k material is deposited by ALD. Each portion of the deposited, high-k material may be annealed before a subsequent portion is deposited. Embodiments of the high-k structure and a capacitor including the high-k structure are also disclosed, as is an embodiment of a method of forming the capacitor.

As used herein, the term “atomic layer deposition” refers to a deposition process in which a plurality of consecutive deposition cycles is conducted in a deposition chamber. ALD also includes atomic layer epitaxy (“ALE”). In ALD, a first metal precursor is chemisorbed to a surface of a substrate, forming approximately a monolayer of the first metal. Excess first metal precursor is purged from the deposition chamber. A second metal precursor and, optionally, a reaction gas, are introduced into the deposition chamber. Approximately a monolayer of the second metal is formed, which reacts with the monolayer of the first metal. Excess reaction gas, excess second metal precursor, and by-products are removed from the deposition chamber. By repeating the ALD pulses, monolayers of the first metal and the second metal are formed until a desired thickness of the material is achieved. ALD is well known in the art and, therefore, is not described in detail herein.

The high-k structure may be formed on a substrate. As used herein, the term “substrate” refers to a base material or construction upon which the high-k structure is deposited. The substrate may be a semiconductor substrate, a base semiconductor layer on a supporting structure, a metal electrode, or a semiconductor substrate having one or more layers, structures, or regions formed thereon.

The high-k structure may be formed from multiple portions of a high-k material, such as a perovskite-type material having the general chemical structure of ABO₃, where A and B are metal cations having different sizes. For the sake of example only, A is barium, strontium, lead, zirconium, lanthanum, potassium, magnesium, titanium, lithium, aluminum, bismuth, or combinations thereof and B is titanium, niobium, tantalum, or combinations thereof. The perovskite-type material may be a titanate including, but not limited to, barium titanate, STO, barium strontium titanate, lead titanate, lead zirconate titanate, lead lanthanum zirconate titanate, barium lanthanum titanate, barium zirconium titanate, or combinations thereof. In another embodiment, the high-k structure may be formed from hafnium oxide, a niobate, or a tantalate. The niobate or tantalate may include, but is not limited to, lead magnesium niobate, lithium niobate, lithium tantalate, potassium niobate, strontium aluminum tantalate, potassium tantalum niobate, barium strontium niobate, lead barium niobate, barium titanium niobate, strontium bismuth tantalate, or bismuth titanate.

The high-k structure may also include combinations of the above-mentioned materials, such as two or more of these materials. For instance, multiple high-k materials may be used, each forming a portion of the high-k structure.

The high-k structure may be formed by conducting multiple ALD cycles and multiple anneal cycles, with each ALD and anneal cycle producing a portion of the high-k structure. As used herein, the term “ALD and anneal cycle” refers to an ALD cycle followed by an anneal cycle. A desired thickness of the high-k structure may be achieved by depositing and annealing a plurality of portions of the high-k material. ALD of perovskite-type materials, such as those described above, is well known in the art. As such, ALD of these materials is not described in detail herein. Metal precursors of the desired perovskite-type material may be introduced into an ALD chamber that includes the substrate upon which the high-k structure is to be formed. Each portion of the high-k material may be deposited on the substrate at an appropriate temperature for ALD, such as at a temperature within a range of from approximately 25° C. to approximately 400° C. The substrate may be a conductive material, such as polysilicon or a metal including, but not limited to, platinum, aluminum, iridium, rhodium, ruthenium, titanium, tantalum, tungsten, and alloys thereof, as well as combinations thereof. As deposited, the portion of the high-k material may be in a substantially amorphous state and have a low k.

The deposited portion of the high-k material may be annealed at a temperature greater than or approximately equal to a temperature at which the high-k material transitions from an amorphous state to a crystalline state. This temperature is referred to herein as the “crystalline temperature.” The crystalline temperature may vary depending on the material used and the thickness of the portions of the high-k material. The anneal may convert the high-k material from the substantially amorphous state to a substantially crystalline state. The anneal may be conducted in an oxidizing environment, such as in an oxygen—(“O₂”) or ozone—(“O₃”) environment. The portion of the high-k material may be annealed for an amount of time sufficient to convert the high-k material to the crystalline state. The anneal temperature may be determined by x-ray diffraction (“XRD”). Each of the anneal temperature and the anneal time may be selected such that the combination of the anneal temperature and the anneal time high-k material converts the high-k material to the crystalline state. For instance, if a higher anneal temperature is used, a shorter anneal time may be needed. Conversely, if a lower anneal temperature is used, a longer anneal time may be needed. After the anneal, the deposited portion of the high-k material may be substantially homogeneous and may be substantially crystalline.

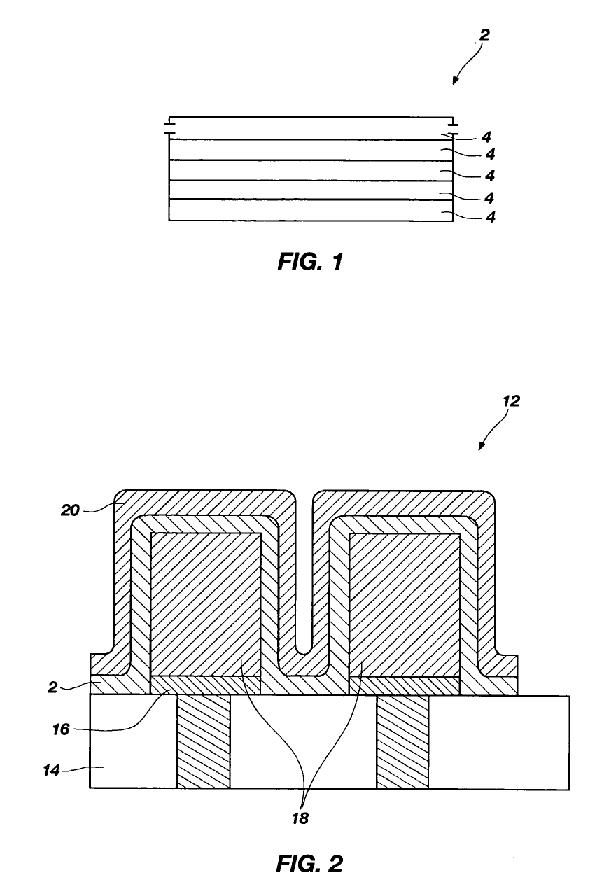

By repeating the deposition and anneal stages described above, with subsequent portions of the high-k material being deposited on previously-deposited portions, a desired, total thickness of the high-k structure may be achieved. As illustrated in FIG. 1, the high-k structure 2 includes multiple portions 4 of the high-k material. As described above, each of the portions 4 may be annealed before depositing a subsequent portion 4. For the sake of example only, the high-k structure 2 may be formed by depositing two or three portions of the high-k material, such as by conducting two or three ALD and anneal cycles. However, additional deposition and anneal stages maybe used to achieve the desired total thickness of the high-k structure 2. Each ALD cycle may deposit a portion of the high-k material having a thickness within a range of from approximately 0.3 nm to approximately 30 nm. For instance, the portion 4 of the high-k material may have a thickness within a range of from approximately 1 nm to approximately 20 nm. The high-k structure 2 may have a total thickness within a range of from approximately 4 nm to approximately 100 nm.

By depositing and annealing the multiple portions 4 of the high-k material, a crystalline template for subsequent film growth may be provided. In addition, growth and control of the amorphous to crystalline phase content of the high-k structure 2 may be controlled. Without being bound by a particular theory, it is believed that the anneals of the high-k material enable the high-k material to change from the amorphous state to a substantially crystalline, perovskite state. As a result, the high-k structure 2 may be in a substantially crystalline form and low leakage current and a high k may be achieved. When crystalline, the perovskite-type materials may have a cubic (titanates), tetragonal, orthorhombic, or rhombohedral crystal structure. In addition, good step coverage of the high-k structure 2 is achieved. The high-k structure 2 may have a k greater than approximately 80 for a structure having a thickness of approximately 15 nm. For instance, the k of an approximately 15 nm, high-k structure may be approximately 120. The high-k structure may also have a low leakage current, such as from approximately 1×10⁻⁹ A/cm² at 1.5V to approximately 1×10¹⁵ A/cm² at 1.5V.

While the example below describes forming STO layers or films, a hafnium oxide layer, other titanate layers, niobate layers, tantalate layers, or other structures formed from the above-mentioned perovskite materials, may be formed using appropriate metal precursors and by adjusting the anneal conditions. For instance, the anneal times and/or the anneal temperatures may be adjusted since hafnium oxide, niobates, and tantalates may have different crystalline temperatures than titanates, such as STO.

For the sake of example only, the high-k structure 2 may be a high-k layer used as a dielectric layer in a capacitor, such as in a planar cell, trench cell (e.g., double sidewall trench capacitor), stacked cell (e.g., crown, V-cell, delta cell, multi-fingered, or cylindrical container stacked capacitor), or a field effect transistor device. An embodiment of a capacitor of a DRAM memory device 12 or memory cell is shown in FIG. 2. The memory device 12 includes the capacitor, a silicon-containing layer 14, and a conductive layer 16. Only those process acts and structures necessary to understand the embodiments of the present invention are described in detail below. Additional acts to form the memory device 12 may be performed by conventional fabrication techniques, which are not described in detail herein. The capacitor includes a first electrode 18, the high-k structure 2, and a second electrode 20. The conductive layer 16 is positioned between the silicon-containing layer 14 and the first electrode 18. The first electrode 18 and the second electrode 20 may be formed from platinum, aluminum, iridium, rhodium, ruthenium, titanium, tantalum, tungsten, alloys thereof, or combinations thereof, or polysilicon. To form the capacitor, each of the first electrode 18 and the second electrode 20 may be deposited by conventional techniques, such as by sputter deposition, CVD, ALD, or other suitable technique. For instance, the first electrode 18 and the second electrode 20 may be sputter deposited at room temperature. The high-k structure 2 may be formed, in multiple portions 4 as described above, over the first electrode 18. The high-k structure 2 may be in contact with substantially all of the first electrode 18. After depositing and annealing the last portion of the high-k material, the second electrode 20 may be formed over the high-k structure 2. The capacitor may be subjected to a final anneal, such as a rapid thermal process, in an oxidizing environment. The final anneal may be conducted at a temperature compatible with the materials used as the first and second electrodes 18, 20 and as the high-k structure 2, such as at a temperature within a range of from approximately 545° C. to approximately 650° C. The final anneal may repair sputter-induced damage or defects caused by depositing the second electrode 20 and may ensure that the high-k structure 2 is in a substantially crystalline, perovskite state. The final anneal may also improve an interface between the high-k structure 2 and the first and second electrodes 18, 20. After the final anneal, the high-k structure 2 may be substantially homogeneous and may be substantially crystalline.

The high-k structure 2 formed by the above-mentioned method may also be used in other applications where a substantially crystalline layer or other structure of a perovskite-type material is desired, such as in optical or tuning applications. For the sake of example only, the high-k structure 2 may be used in high-frequency tunable devices, decoupling capacitors, or gate dielectrics.

For the sake of example only, the formation of an STO layer in contact with platinum substrates is described. One ALD cycle may be conducted to form one of a plurality of portions of the STO material on a first platinum substrate. The ALD cycle may include separately introducing or pulsing strontium precursors and titanium precursors into the ALD chamber that includes the first platinum substrate. Strontium precursors and titanium precursors suitable for forming the STO layer by ALD are well known in the art and, therefore, are not described in detail herein. For the sake of example only, the strontium precursor may include, but is not limited to, a cyclopentadienyl compound, Sr[N(SiMe₃₎₂]₂, a strontium diorganoamide precursor, Sr(C₁₁H₁₉O₂)₂ (“Sr(THD)₂”), strontium (tetramethylheptanedionate), Sr(C₁₁H₂₁N₂)₂ (“Sr(diketimine)₂” or “SDBK”), or combinations thereof. The titanium precursor may include, but is not limited to, titanium tetramethoxide, titanium tetraethoxide, titanium tetra-n-propoxide, titanium tetraisopropoxide, titanium tetra-n-butoxide, titanium tetra-t-butoxide, titanium tetra-2-ethylhexoxide, tetrakis(2-ethylhexane-1,3-diolato) titanium, titanium diisopropoxide bis(acetylacetonate), titanium diisopropoxide bis(2,2,6,6-tetramethyl-3,5-heptanedionate), titanium bis(ethyl acetacetato)diisopropoxide, bis(ethylacetoacetato) bis(alkanolato)titanium, tetrakis(dimethylamino)titanium, tetrakis(diethylamino)titanium, tetrakis(ethylmethylamino)-titanium, titanium(triethanolaminato)isopropoxide), Ti(C₆H₁₂O₂)(C₁₁H₁₉O₂)₂ (“Ti(MPD)(thd)₂”), titanium(methylpentanedione)(tetramethylheptanedionate), or combinations thereof. The portion of the STO material may be deposited at a temperature of approximately 300° C. The deposited portion of the STO material may be substantially amorphous.

The deposited portion of the STO material may be annealed at a temperature within a range of from approximately 545° C. to approximately 625° C., such as from approximately 550° C. to approximately 600° C. The deposited portion of the STO material may be annealed for an amount of time within a range of from approximately 2 minutes to approximately 15 minutes. However, the anneal time may be adjusted depending on the temperature used in the anneal. If a lower temperature is used, the anneal time may be longer than the above-mentioned range. Conversely, if a higher temperature is used, the anneal time may be shorter than the above-mentioned range. The anneal may be conducted in an oxygen environment. Additional portions of the STO material may be deposited and annealed, as described above, until the desired thickness of the STO layer is achieved. After each anneal, the newly-deposited portion of the STO material may be in a substantially crystalline state. After depositing and annealing the last portion of the STO material, a second platinum substrate may be formed over the STO layer and the structure may be finally annealed, such as at a temperature of approximately 600° C. in an oxygen environment for approximately 5 minutes. The STO layer may be in a substantially crystalline, perovskite state.

The following example serves to explain embodiments of the present invention in more detail. This example is not to be construed as being exhaustive or exclusive as to the scope of this invention.

### EXAMPLE

### Example 1

Formation and Electrical Properties of 15 nm, 31 nm, and 100 nm STO Films

STO stacks having an STO film positioned between two layers of platinum were formed. Each layer of platinum (“Pt”) was sputter-deposited to a thickness of 30 nm. STO films having a total thickness of 15 nm, 31 nm, or 100 nm were formed by conducting multiple ALD and anneal cycles, with each ALD and anneal cycle producing a portion of the STO film.

To form the 15 nm STO film, a 5 nm portion of the STO material was deposited by ALD at 300° C. on a first platinum layer. Each portion of the STO material was deposited as follows:
Ti precursor pulse (60 sec)/purge (30 sec)/oxidizer O₃ (30 sec)/purge (20 sec)=1 TiO₂ cycle
Sr precursor pulse (30 sec)/purge (30 sec)/oxidizer 03 (30 sec)/purge (30 sec)=1 SrO cycle
Sr Flow: 0.8 ml/min, 30 sec-60 sec
Ti Flow: 0.8 ml/min, 40 sec-60 sec
THF: 0.4 ml/min-1.0 ml/min, 15 sec-30 sec
O₃ concentration: 15% by volume
O₃ flow rate: 1.5 standard liters per minute for 30 sec-60 sec
Process pressure: 1 Torr-2 Torr
Vaporizer temperature: 290° C.
Tsub: approximately 300° C.-350° C.
   The TiO₂ and SrO cycles were repeated to obtain the 5 nm portion of the STO material. The 5 nm portion was annealed at 550° C.

Additional stages of depositing 5 nm and annealing were conducted until the desired thickness of 15 nm was achieved. To form the 31 nm STO film, an approximately 10 nm portion of the STO material was deposited by ALD at 300° C. on the first platinum layer, followed by anneal at 550° C. Additional stages of depositing approximately 10 nm and annealing were conducted until the desired thickness of 31 nm was achieved. To form the 100 nm STO film, a 20 nm portion of the STO material was deposited by ALD at 300° C. on the first platinum layer, followed by anneal at 550° C. Additional stages of depositing 20 nm and annealing were conducted until the desired thickness was achieved. A second platinum layer was deposited over the 15 nm STO film, the 31 nm STO film, or the 100 nm STO film, and the STO stacks were subjected to a final anneal at 600° C. The 15 nm, 31 nm, and 100 nm STO films were substantially crystalline.

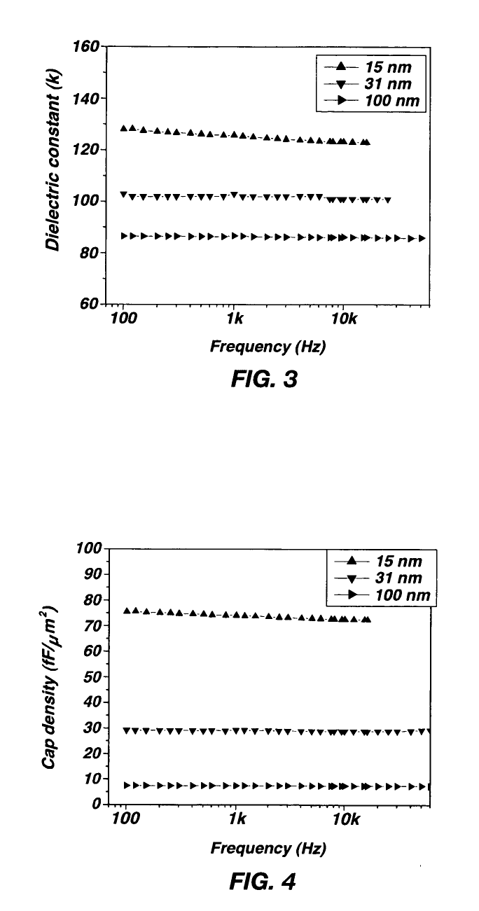

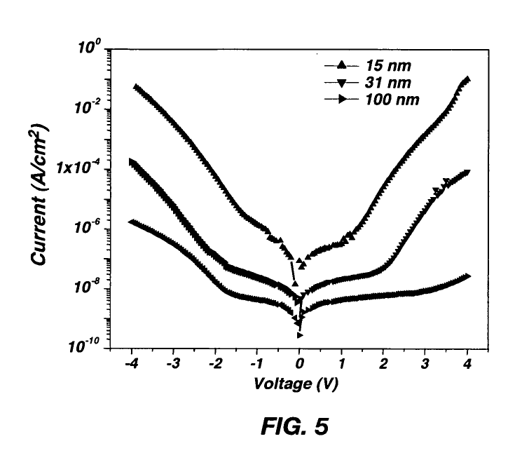

Electrical properties (dielectric constant, capacitance density, and leakage current density) of the STO films were measured by conventional techniques. A plot of dielectric constant (k) versus frequency is shown in FIG. 3, a plot of capacitance density versus frequency is shown in FIG. 4, and a plot of current versus voltage is shown in FIG. 5. Table 1 provides a summary of the capacitance densities, k, and leakage current densities for these layers.

TABLE 1
Electrical Properties of the 15 nm, 31 nm, and 100 nm STO films.

| | | Capacitance | | JL |
|---|---|---|---|---|
| | | Density | k at | (A/cm²) |
| | | (fF/μm²) | 10 | at |
| STO Stack | Anneal Conditions | at 10 KHz) | KHz | 1.5 V |
| Pt/STO/Pt | Form Pt Electrode/ | 8 | 86 | 5 × 10⁻⁹ |
| (100 nm STO) | Form STO/Anneal | | | |
| | STO at 550° C./Form | | | |
| | Pt Electrode/Final | | | |
| | anneal at 600° C. | | | |
| Pt/STO/Pt | Form Pt | 29 | 101 | 2 × 10⁻⁸ |
| (31 nm STO) | Electrode/Form | | | |
| | STO/Anneal STO | | | |
| | at 550° C./Form Pt | | | |
| | Electrode/Final | | | |
| | anneal at 600° C. | | | |
| Pt/STO/Pt | Form Pt | 73 | 120 | 2 × 10⁻⁶ |
| (15 nm STO) | Electrode/Form | | | |
| | STO/Anneal STO | | | |
| | at 550° C./Form Pt | | | |
| | Electrode/Final | | | |
| | anneal at 600° C. | | | |

For comparison, capacitance densities, k, and leakage current densities were measured for 100 nm STO films that were conventionally deposited by ALD. In other words, the 100 nm STO films were formed in a single portion by ALD. The 100 nm STO films were either not annealed (as deposited) or were annealed at 550° C. or 650° C., as shown in Table 2.

TABLE 2
Electrical Properties of Control 100 nm STO films.

| | | Capacitance | | Leakage |
|---|---|---|---|---|
| STO Stack | | Density | | current |
| Pt/STO/Pt | Anneal | fF/μm² | k at | J_{L} (A/cm²) |
| (100 nm) | Conditions | at 10 kHz | 10 kHz | at 1.5 V |
| No anneal | As deposited | 1.1 | 12 | 2 × 10⁻⁸ |
| Anneal | 550° C./O₂/5 min | 1.5 | 17 | 3 × 10⁻⁹ |
| Anneal | 650° C./O₂/5 min | — | — | Electrical short |

STO films having thicknesses of 15 nm and 31 nm were also deposited in a single portion by ALD. These STO films had electrical shorts and, therefore, capacitance density, k, and leakage current density were not measured. The STO films formed utilizing the multiple ALD deposition and anneal cycles and the final anneal (shown in Table 1) had higher dielectric constants and lower leakage current densities than the control STO films (shown in Table 2), which were deposited as a single portion.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method of forming a structure, comprising:
forming a high-k structure from a plurality of portions of a high-k material, wherein each of the plurality of portions of the high-k material is formed by:
depositing a plurality of monolayers of the high-k material; and
annealing the high-k material.

2. The method of claim 1, wherein forming a high-k structure from a plurality of portions of a high-k material comprises forming a strontium titanate structure.

3. The method of claim 1, wherein depositing a plurality of monolayers of the high-k material comprises depositing the high-k material by atomic layer deposition.

4. The method of claim 1, wherein depositing a plurality of monolayers of the high-k material comprises depositing a high-k material selected from the group consisting of barium titanate, strontium titanate, barium strontium titanate, lead titanate, lead zirconate titanate, lead lanthanum zirconate titanate, barium lanthanum titanate, barium zirconium titanate, hafnium oxide, lead magnesium niobate, lithium niobate, lithium tantalate, potassium niobate, strontium aluminum tantalate, potassium tantalum niobate, barium strontium niobate, lead barium niobate, barium titanium niobate, strontium bismuth tantalate, bismuth titanate, and combinations thereof.

5. The method of claim 1, wherein annealing the high-k material comprises converting the deposited high-k material from an amorphous state to a substantially crystalline state.

6. The method of claim 1, wherein annealing the high-k material comprises heating the high-k material to a temperature greater than or approximately equal to a crystalline temperature of the high-k material.

7. The method of claim 1, wherein annealing the high-k material comprises heating the high-k material to a temperature within a range of from approximately 545° C. to approximately 625° C.

8. The method of claim 7, wherein annealing the high-k material comprises heating the high-k material for from approximately 2 minutes to approximately 15 minutes.

9. The method of claim 1, wherein annealing the high-k material comprises heating the high-k material to a temperature within a range of from approximately 550° C. to approximately 600° C.

10. The method of claim 1, wherein forming a high-k structure from a plurality of portions of a high-k material comprises forming a substantially homogeneous high-k structure.

11. The method of claim 1, wherein forming a high-k structure from a plurality of portions of a high-k material comprises forming a substantially crystalline high-k structure.

12. The method of claim 1, wherein forming a high-k structure from a plurality of portions of a high-k material comprises forming a high-k structure having a thickness of approximately 15 nm and a dielectric constant of greater than approximately 80.

13. The method of claim 1, wherein forming a high-k structure from a plurality of portions of a high-k material comprises forming a high-k structure having a thickness of approximately 15 nm and a dielectric constant of approximately 120.

14. The method of claim 1, wherein forming a high-k structure from a plurality of portions of a high-k material comprises forming a first portion of the plurality of portions of the high-k material on a substrate.

15. The method of claim 14, wherein forming a high-k structure from a plurality of portions of a high-k material comprises forming subsequent portions of the plurality of portions of the high-k material on previously-formed portions of the high-k material.

16. A method of forming a strontium titanate layer, comprising:
forming a strontium titanate layer from a plurality of portions of strontium titanate, wherein each of the plurality of portions of strontium titanate is formed by:
depositing a plurality of monolayers of strontium titanate; and
annealing the strontium titanate.

17. The method of claim 16, wherein depositing a plurality of monolayers of strontium titanate comprises forming the strontium titanate layer by atomic layer deposition.

18. The method of claim 16, wherein annealing the strontium titanate comprises heating the strontium titanate to a temperature within a range of from approximately 550° C. to approximately 600° C.

19. The method of claim 18, wherein annealing the strontium titanate comprises heating the strontium titanate for from approximately 2 minutes to approximately 15 minutes.

20. A structure having a high dielectric constant, comprising:
a plurality of portions of a high-k material, wherein each of the plurality of portions of the high-k material is substantially crystalline.

21. The structure of claim 20, wherein each of the plurality of portions of the high-k material is substantially homogeneous.

22. The structure of claim 20, wherein the structure has a thickness of approximately 15 nm and a dielectric constant of greater than approximately 80.

23. The structure of claim 20, wherein the structure has a thickness of approximately 15 nm and a dielectric constant of approximately 120.

24. The structure of claim 20, wherein the high-k material is selected from the group consisting of barium titanate, strontium titanate, barium strontium titanate, lead titanate, lead zirconate titanate, lead lanthanum zirconate titanate, barium lanthanum titanate, barium zirconium titanate, hafnium oxide, lead magnesium niobate, lithium niobate, lithium tantalate, potassium niobate, strontium aluminum tantalate, potassium tantalum niobate, barium strontium niobate, lead barium niobate, barium titanium niobate, strontium bismuth tantalate, bismuth titanate, and combinations thereof.

25. A method of forming a capacitor, comprising:
forming a first electrode;
forming a high-k structure from a plurality of portions of a high-k material, wherein each of the plurality of portions of the high-k material is formed by:
depositing a plurality of monolayers of the high-k material; and
annealing the high-k material;
forming a second electrode over the high-k structure; and
annealing the first electrode, the high-k structure, and the second electrode.

26. The method of claim 25, wherein depositing a plurality of monolayers of the high-k material comprises depositing the high-k material by atomic layer deposition.

27. The method of claim 25, wherein annealing the first electrode, the high-k structure, and the second electrode comprises annealing the first electrode, the high-k structure, and the second electrode at a temperature of approximately 600° C.

28. The method of claim 25, wherein forming a high-k structure from a plurality of portions of a high-k material comprises forming a high-k structure having a thickness of approximately 15 nm and a dielectric constant of greater than approximately 80.

29. The method of claim 25, wherein forming a high-k structure from a plurality of portions of a high-k material comprises forming a high-k structure having a thickness of approximately 15 nm and a dielectric constant of greater than approximately 120.

30. The method of claim 25, wherein forming a high-k structure from a plurality of portions of a high-k material comprises forming a high-k structure from a plurality of portions of a high-k material selected from the group consisting of barium titanate, strontium titanate, barium strontium titanate, lead titanate, lead zirconate titanate, lead lanthanum zirconate titanate, barium lanthanum titanate, barium zirconium titanate, hafnium oxide, lead magnesium niobate, lithium niobate, lithium tantalate, potassium niobate, strontium aluminum tantalate, potassium tantalum niobate, barium strontium niobate, lead barium niobate, barium titanium niobate, strontium bismuth tantalate, bismuth titanate, and combinations thereof.

31. A capacitor comprising a first electrode, a high-k structure, and a second electrode, wherein the high-k structure comprises a plurality of portions of a high-k material and wherein each of the plurality of portions of the high-k material is substantially annealed.
